(19) United States
(12) Patent Application Publication
(10) Pub. No.: US 2024/0214737 A1
(43) Pub. Date: Jun. 27, 2024

(54) Diaphragm Assembly and Loudspeaker

(71) Applicant: BEIJING EDIFIER TECHNOLOGY CO., LTD, Beijing (CN)

(72) Inventors: Wendong ZHANG, Beijing (CN); Jun ZHAO, Beijing (CN)

(21) Appl. No.: 18/288,825

(22) PCT Filed: Oct. 18, 2021
(86) PCT No.: PCT/CN2021/124329

§ 371 Date: Oct. 30, 2023

(30) Foreign Application Priority Data
Aug. 13, 2021 (CN) 202110930373.9
Aug. 13, 2021 (CN) 202121893612.X

(51) Int. Cl. H04R 7/06; H04R 3/00; H04R 9/02; H04R 9/06

(52) U.S. Cl. CPC H04R 7/06; H04R 3/00; H04R 9/025; H04R 9/06; H04R 2307/027

(57) ABSTRACT

Disclosed are a diaphragm assembly and a loudspeaker. The diaphragm assembly includes a diaphragm body and a circuit pattern fixedly arranged on the diaphragm body. The diaphragm body is provided with a plurality of magnetized areas. The circuit pattern includes a plurality of copper sheets arranged in a one-to-one correspondence with the magnetized areas, and an isolation gap is arranged between two adjacent copper sheets of the plurality of copper sheets. At least part of the plurality of copper sheets is provided with a plurality of balance gaps arranged in a width direction of the part of the plurality of copper sheets, and each of the part of the plurality of copper sheets is divided into a plurality of narrow strips.

### CROSS-REFERENCE TO RELATED APPLICATION

The disclosure is a National Stage Filing of the PCT International Application No: PCT/CN2021/124329 filed on 18 Oct. 2021, which claims priority to and the benefit of Chinese Patent Application No. 202110930373.9, filed to the China National Intellectual Property Administration (CHIPA) on 13 Aug. 2021, and Chinese Patent Application No. 202121893612.X, filed to the China National Intellectual Property Administration (CHIPA) on 13 Aug. 2021, which are hereby incorporated by reference in their entireties.

### TECHNICAL FIELD

The disclosure relates to the technical field of acoustic diaphragms, in particular to a diaphragm assembly and a loudspeaker.

### BACKGROUND

A diaphragm assembly is one of core components of a loudspeaker, which is mainly configured to vibrate and sound. The conventional diaphragm assembly defines the width dimension of a corresponding copper sheet according to the average magnetic field intensity, so that each of the copper sheets is equal in force per unit width, which has a certain positive effect. However, such a solution still has larger defects, that is, the distance between two adjacent non-copper-clad areas of the conventional diaphragm assembly is uneven, and the weight distribution of a copper foil on both sides is seriously uneven.

### SUMMARY

According to various embodiments of the disclosure, a diaphragm assembly and a loudspeaker are provided.

The diaphragm includes:
a diaphragm body is provided with a plurality of magnetized areas; and
a circuit pattern is fixedly arranged on the diaphragm body, the circuit pattern includes a plurality of copper sheets arranged in a one-to-one correspondence with the plurality of magnetized areas, and an isolation gap is arranged between two adjacent copper sheets of the plurality of copper sheets;
at least part of the plurality of copper sheets is provided with a plurality of balance gaps arranged in a width direction of the part of the plurality of copper sheets, and each of the part of the plurality of copper sheets is divided into a plurality of narrow strips.

In some embodiments, a copper sheet with a smallest width dimension of the plurality of copper sheets is not provided with the plurality of balance gaps.

In some embodiments, a width dimension of each of the plurality of narrow strips is equal to a width dimension of the copper sheet with the smallest width dimension.

In some embodiments, a width dimension of the isolation gap is equal to a width dimension of each of the plurality of balance gaps.

In some embodiments, a width dimension of each of the plurality of narrow strips is larger than a width dimension of the isolation gap.

In some embodiments, all of the plurality of narrow strips belonging to the same copper sheet of the plurality of copper sheets are arranged in parallel.

In some embodiments, the plurality of copper sheets are arranged in parallel.

In some embodiments, the circuit pattern is bonded to the diaphragm body.

In some embodiments, the diaphragm body is made of a material with deformability

The disclosure also provides a loudspeaker, which includes a magnet configured to provide a magnetic field, a circuit board configured to provide current, and the diaphragm assembly described in above, and an end of the circuit pattern is electrically connected to the circuit board.

In some embodiments, the current provided by the circuit board to each of the plurality of copper sheets at the same time is equal.

In some embodiments, a hollow groove is arranged in the middle of the circuit board, and the diaphragm body is fixedly arranged in the hollow groove.

In the diaphragm assembly and the loudspeaker, at least part of the plurality of copper sheets is provided with the plurality of balance gaps, and a copper sheet with a relatively wide width of the part of the plurality of copper sheets is divided into the plurality of narrow strips arranged at intervals, that is, adding the plurality of balance gaps between two adjacent isolation gaps, which is equivalent to adding a plurality of new non-copper-clad areas between two original adjacent non-copper-clad areas. Thus, a distance difference between two adjacent non-copper-clad areas is reduced, a copper-clad uniformity on the diaphragm body is improved, an overall smoothness and stability of the diaphragm assembly during vibration are finally improved, and a sound distortion is reduced.

### BRIEF DESCRIPTION OF THE DRAWINGS

In order to more clearly illustrate the embodiments of the disclosure or the technical solutions in the related art, the drawings used in the description of the embodiments or the related art will be briefly described below. It is apparent that the drawings described below are only some embodiments of the disclosure. Other drawings are able to further be obtained by those of ordinary skill in the art according to these drawings without creative efforts.

FIG. 1 is a structural schematic diagram of a diaphragm assembly provided in the related art.

FIG. 2 is a partial schematic diagram of an area M in FIG. 1.

FIG. 3 is a structural schematic diagram of a diaphragm assembly provided by an embodiment of the disclosure.

FIG. 4 is a partial schematic diagram of an area N in FIG. 3.

### DETAILED DESCRIPTION OF THE EMBODIMENTS

In order to make the objects, features and advantages of the disclosure more obvious and understandable, the technical solutions in the embodiments of the disclosure will be clearly and completely described in conjunction with the drawings in the embodiments of the disclosure. It is apparent that the described embodiments are only a part of the embodiments of the disclosure, and not all of them. All other embodiments obtained by those skilled in the art based on the embodiments of the disclosure without creative efforts are within the scope of the disclosure.

It is to be noted that when an element is referred to as being “fixed to” another element, it may be directly on another element or there may also be a centered element. When an element is considered to be “connected” to another element, it may be directly connected to another element or there may be a centered element at the same time. The terms “inner”, “outer”, “left”, “right” and the like as used herein are for illustrative purposes only and do not represent the only embodiments.

In addition, the terms “long”, “short”, “inner”, “outer” and the like indicate the orientation or positional relationship based on the orientation or positional relationship shown in the drawings, and are only for the convenience of describing the disclosure, but do not indicate or imply the device referred to. Or the original must have this specific orientation and be operated in a specific orientation structure, which cannot be understood as a limitation of the disclosure.

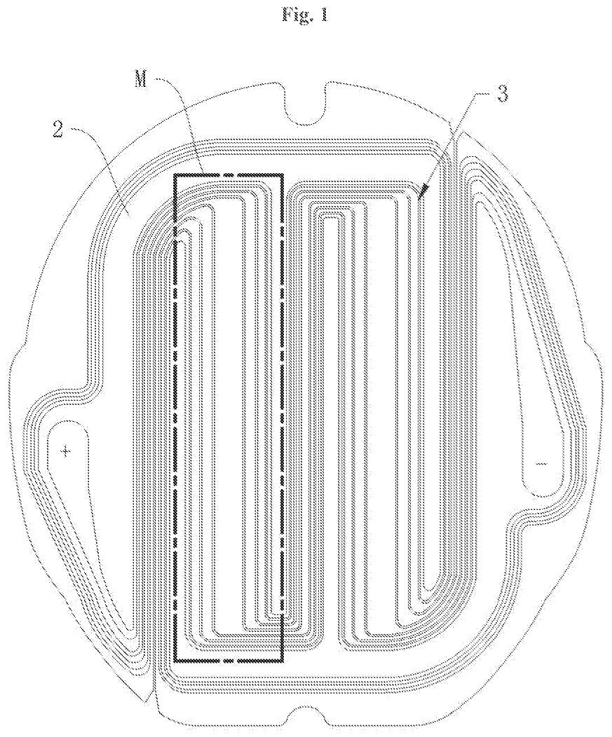

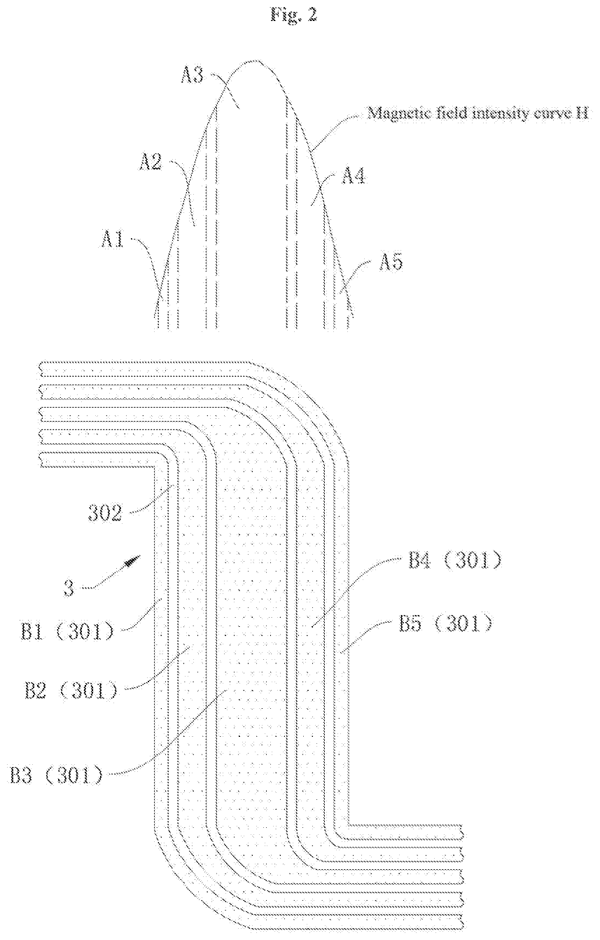

Referring to FIG. 1 and FIG. 2, a diaphragm assembly is provided in the related art, which includes a diaphragm body 2 and a circuit pattern 3 fixedly arranged on the diaphragm body 2. The circuit pattern 3 is made by a copper foil or an aluminum foil by a developing etching process, and includes a plurality of copper sheets 301 arranged at intervals by taking the copper foil as an example. The diaphragm assembly is placed in a magnetic field, and then the circuit pattern 3 is energized, so that the circuit pattern 3 drives the diaphragm body 2 to vibrate up and down under the action of the ampere force and finally make a sound.

The magnetic field intensities corresponding to various positions on the diaphragm body 2 are different. An uneven force on each of various positions on the diaphragm body 2 easily causes a frequency and amplitude of the vibration of each of various positions of the diaphragm body 2 to be greatly different, and ultimately results in a serious problem of sound distortion.

An area M in FIG. 1 is a main area vibrated by the ampere force, and the area M is taken as an example for introduction. Referring to FIG. 2, generally, a magnetic field intensity of the area M is shown by a magnetic field intensity curve H. In order to make the force on each of various positions on the diaphragm body more uniform, an existing diaphragm assembly adopts the following technical solutions.

(1) The diaphragm body in the area M is divided into a plurality of magnetized areas according to the magnetic field intensity, for example, it is divided into a magnetized area A1, a magnetized area A2, a magnetized area A3, a magnetized area A4, a magnetized area A5 and alike. In some embodiments, the diaphragm body in the area M may also be divided into three, six or seven magnetized areas, and the principles are the same. The following mainly introduces the situation when five magnetized areas are divided.

(2) An average magnetic field intensity of each of the plurality of magnetized areas is calculated, for example, an average magnetic field intensity of the magnetized area A1 is 1H, an average magnetic field intensity of the magnetized area A2 is 2H, an average magnetic field intensity of the magnetized area A3 is 5H, an average magnetic field intensity of the magnetized area A4 is 2H, and an average magnetic field intensity of the magnetized area A5 is 1H.

(3) A width dimension of the corresponding copper sheet is calculated according to the average magnetic field intensity of each of the plurality of magnetized areas. Herein, the width dimension of the copper sheet is proportional to the average magnetic field intensity of the corresponding magnetized area. For example, a width dimension of a copper sheet corresponding to the magnetized area A1 is 1 L, a width dimension of a copper sheet corresponding to the magnetized area A2 is 2 L, a width dimension of a copper sheet corresponding to the magnetized area A3 is 5 L, a width dimension of a copper sheet corresponding to the magnetized area A4 is 2 L, and a width dimension of a copper sheet corresponding to the magnetized area A5 is 1 L.

(4) Developing etching is performed on the copper foil according to the width dimension of each of the plurality of copper sheets to obtain a circuit pattern including the plurality of copper sheets arranged at intervals. For example, the circuit pattern includes a copper sheet B1 located on the magnetized area A1, a copper sheet B2 located on the magnetized area A2, a copper sheet B3 located on the magnetized area A3, a copper sheet B4 on the magnetized area A4, and a copper sheet B5 on the magnetized area A5 in sequence. An isolation gap 302 is arranged between two adjacent copper sheets.

(5) An equal current is applied to each of the plurality of copper sheets, and a current corresponding to the unit width dimension of each of the plurality of copper sheets is inversely proportional to the width dimension of each of the plurality of copper sheets, that is, a current per unit width of a copper sheet B1 is 11, a current per unit width of a copper sheet B2 is 1/2l, a current per unit width of a copper sheet B3 is 1/5l, a current per unit width of a copper sheet B4 is 1/2l, and a current per unit width of a copper sheet B5 is 11.

(6) Generally, a length dimension of each of the plurality of copper sheets is equal. Due to the fact that the ampere force is proportional to the magnetic field intensity and inversely proportional to the current, a force corresponding to the unit width dimension of each of the plurality of copper sheets is equal, that is, a force per unit width of the copper sheet B1 is 1 L×11=1F, a force per unit width of the copper sheet B2 is 2 L×1/2l=1F, a force per unit width of the copper sheet B3 is 5 L×1/5l=1F, a force per unit width of the copper sheet B4 is 2 L×1/2l=1F, and a force per unit width of the copper sheet B5 is 1 L×11=1 F.

The diaphragm assembly provided by the related art defines the width dimension of the corresponding copper sheet according to the average magnetic field intensity, so that the force per unit width of each of the plurality of copper sheets is equal, which has a certain positive effect. However, a weight distribution of the copper foil on both sides of the isolation gap 302 of the diaphragm body in the diaphragm assembly is seriously uneven.

For example, taking a isolation gap C₂₋₃ between the magnetized area A2 and the magnetized area A3 as an example, a left side of the isolation gap C₂₋₃ is provided with the copper foil within a width of 2 L, a right side of the isolation gap Cza is provided with the copper foil within a width of 5 L, and the weight distribution of the copper foil is obviously asymmetric.

An area that is not covered by the circuit pattern is called a non-copper-clad area, and a distance between two adjacent non-copper-clad areas of the diaphragm assembly in the related art is obviously uneven.

The technical solutions of the disclosure will be further described below in conjunction with the drawings and specific embodiments.

The disclosure provides a diaphragm assembly and a loudspeaker provided with the diaphragm assembly. It is to be noted that the loudspeaker of the disclosure is able to be used as a car speaker, a smart speaker, an earphone, or other audio devices.

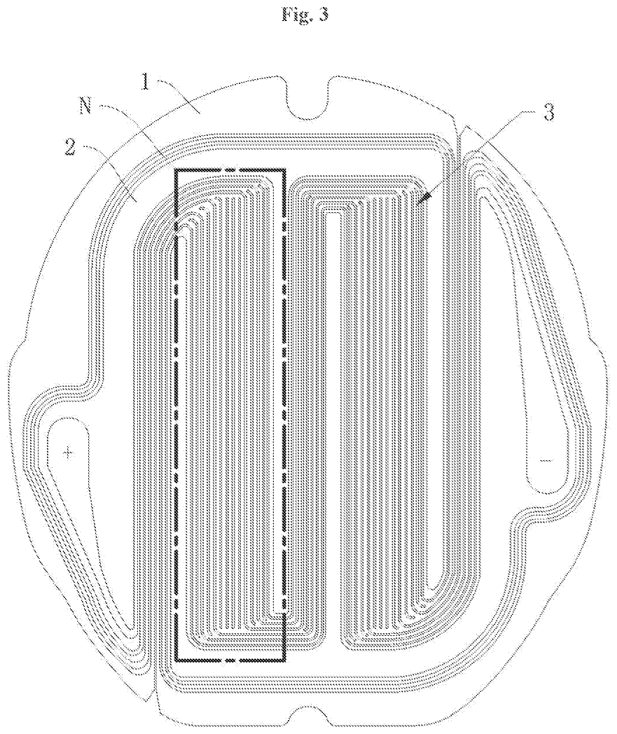

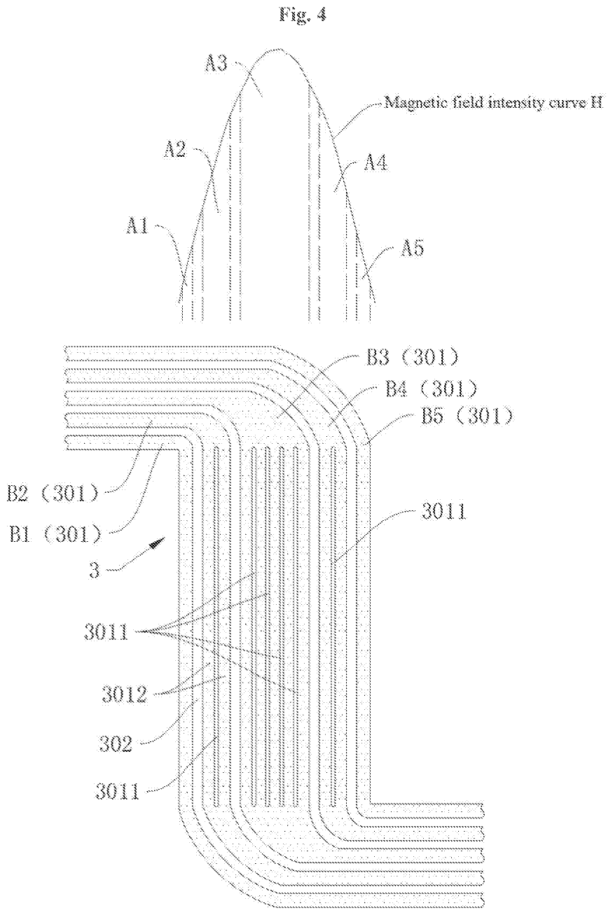

As shown in FIG. 3 and FIG. 4, in the embodiment, the diaphragm assembly for the loudspeaker is taken as an example. The loudspeaker includes a circuit board 1 with a hollow groove in the middle, a diaphragm assembly fixedly arranged in the hollow groove, and a magnet arranged opposite to the diaphragm assembly and configured to provide a magnetic field. The diaphragm assembly includes a diaphragm body 2 made of a substrate with a certain deformability such as a Polyethylene Terephthalate (PET) polymer material and a circuit pattern 3 spread out in a plane structure, and the circuit pattern 3 is fixedly connected to the diaphragm body 2.

The circuit pattern 3 in the diaphragm assembly is electrically connected to the circuit board 1, and the energized circuit pattern 3 drives the diaphragm body 2 to reciprocate and deform in a thickness direction of the diaphragm assembly under an action of the magnetic field generated by the magnet, so as to vibrate and make a sound.

In some embodiments, the diaphragm assembly includes the diaphragm body 2 and the circuit pattern 3, and the circuit patter 3 is bonded to the diaphragm body 2.

In the embodiment, an area N is a main vibration area of the diaphragm assembly. Taking the area N as an example, the diaphragm body 2 is provided with a plurality of magnetized areas. The circuit pattern 3 includes a plurality of copper sheets 301 arranged in a one-to-one correspondence with the plurality of magnetized areas, and an isolation gap 302 is arranged between two adjacent copper sheets 301 of the plurality of copper sheets 301.

At least part of the plurality of copper sheets 301 is provided with a plurality of balance gaps 3011 arranged in a width direction of the part of the plurality of copper sheets 301, and each of the part of the plurality of copper sheets 301 is divided into a plurality of narrow strips 3012.

Specifically, the part of the plurality of copper sheets 301 is provided with the plurality of balance gaps 3011, so that a copper sheet 301 with a relatively wide width of the part of the plurality of copper sheets 301 is divided into the plurality of narrow strips 3012. That is, adding the plurality of balance gaps 3011 between two adjacent isolation gaps 302 is equivalent to adding a plurality of new non-copper-clad areas between two original adjacent non-copper-clad areas. Thus, a distance difference between two adjacent non-copper-clad areas is reduced, a copper-clad uniformity on the diaphragm body 2 is improved, an overall smoothness and stability of the diaphragm assembly during vibration are finally improved, and sound distortion is reduced.

In some embodiments, a width dimension of each of the plurality of narrow strips 3012 is specified based on a copper sheet 301 with a smallest width dimension of the plurality of copper sheets 301, that is, the copper sheet 301 with the smallest width dimension is not provided with the plurality of balance gaps 3011, and then the width dimension of each of the plurality of narrow strips 3012 is equal to the width dimension of the copper sheet 301 with the smallest width dimension. In this way, it is ensured that a distance between two adjacent non-copper-clad areas is consistent, and a distribution uniformity of the plurality of narrow strips 3012 is improved to a certain extent.

In some other embodiments, a width dimensions of the isolation gap 302 is equal to a width dimension of each of the plurality of balance gaps 3011, that is, a distance between two adjacent narrow strips 3012 of the plurality of narrow strips 3012 is also consistent, and the distribution uniformity of the plurality of narrow strips 3012 is further improved, so that an uniformity of the force on the diaphragm body 2 is greatly improved, and the sound distortion is significantly reduced.

In some yet other embodiments, the width dimension of each of the plurality of narrow strips 3012 is larger than the width dimension of the isolation gap 302, so as to avoid the occurrence of insufficient vibration force caused by excessive emptying.

In the embodiment, the plurality of copper sheets 301 are arranged in parallel, that is, a current provided by the circuit board to each of the plurality of copper sheets 301 at the same time is equal. Further, the same ends of all of the plurality of narrow strips 3012 belonging to the same copper sheet 301 of the plurality of copper sheets 301 are electrically connected to each other, that is, all of the plurality of narrow strips 3012 belonging to the same copper sheet 301 of the plurality of copper sheets 301 are also arranged in parallel. A number of the plurality of narrow strips 3012 separated by each of the plurality of copper sheets 301 is proportional to the average magnetic field intensity of the corresponding magnetized area, so that the current passing through each of the plurality of narrow strips 3012 belonging to the same copper sheet 301 of the plurality of copper sheets 301 is the same, a weight of each of the plurality of narrow strips 3012 is the same, and an ampere force is also the same.

The following is an example to illustrate the situation when the number of magnetized areas is five.

(1) As shown in FIG. 4, the diaphragm body is divided into the magnetized area A1, the magnetized area A2, the magnetized area A3, the magnetized area A4, and the magnetized area A5. The corresponding copper sheets are marked as the copper sheet B1, the copper Sheet B2, the copper sheet B3, copper sheet B4, and the copper sheet B5. The isolation gap 302 is arranged between two adjacent copper sheets 301.

(2) Assuming that the average magnetic field intensity of the magnetized area A1 is 1H, the average magnetic field intensity of the magnetized area A2 is 2H, the average magnetic field intensity of the magnetized area A3 is 5H, the average magnetic field intensity of the magnetized area A4 is 2H, and the average magnetic field intensity of A5 is 1H, the copper sheet B1 and the copper sheet B5 remain unchanged. The balance gaps 3011 are respectively arranged in the copper sheet B2 and the copper sheet B4, so that the copper sheet B2 and the copper sheet B4 are respectively separated into two narrow strips 3012. Four balance gaps 3011 are arranged in the copper sheet B3, so that the copper sheet B3 is equally divided into five narrow strips 3012. Herein, the width dimensions of the copper sheet B1, the narrow strips 3012 and the copper sheet B5 are equal, and the width dimensions of each balance gap 3011 and each isolation gap 302 are also equal.

(3) After the circuit board 1 applies equal current to each copper sheet 301, the current corresponding to each narrow strip 3012 is inversely proportional to the number of separated copper sheets 301, that is, the current of the copper sheet B1 is 11, the current of the copper sheet B2 is 1/2l, the current of the copper sheet B3 is 1/5l, the current of the copper sheet B4 is 1/2l, and the current of the copper sheet B5 is 11.

(4) Generally, the length dimension of each of the plurality of narrow strips 3012 is equal. Due to the fact that the ampere force is proportional to the magnetic field intensity and inversely proportional to the current, so that the force on each of the plurality of narrow strips 3012 is equal, that is, the force on the copper sheet B1 is 1 L×11=1F, the force on each of the plurality of narrow strips of the copper sheet B2 is 2 L×1/2l=1F, the force on each of the plurality of narrow strips of the copper sheet B3 is 5 L×1/5l=1F, the force on each of the plurality of narrow strips of the copper sheet B4 is 2 L×1/2l=1F, and the force on each of the plurality of narrow strips of the copper sheet B5 is 1 L×11=1 F. Further, the width dimension of each of the plurality of narrow strips 3012 is equal, so that the weight of each of the plurality of narrow strips 3012 is also equal.

Therefore, in the diaphragm assembly provided by the embodiment, a narrow strip 3012 of the plurality of narrow strips 3012 between two adjacent non-copper-clad areas has the same weight and the same force condition, which greatly improves the vibration smoothness and stability of the diaphragm body 2.

Further, in the diaphragm assembly provided by the embodiment of the disclosure, the copper sheet of the same quality is able to be laid with a larger area of the diaphragm body, thereby saving materials. The interval between two adjacent non-copper-clad areas is the same, so that the distance difference between two adjacent non-copper-clad areas is reduced, the copper-clad uniformity on the diaphragm body is improved, the overall smoothness and stability of the diaphragm assembly during vibration are finally improved, and sound distortion is reduced. A shape of the diaphragm body is not limited, for example, it may be rectangular, circular, elliptical or irregular polygon, etc. The corresponding magnetized area is obtained through reasonable area division, and then the wiring design is performed, and the adaptability of the diaphragm assembly is stronger.

The technical features of the above-described embodiments are able to be arbitrarily combined. For the sake of brevity of description, all possible combinations of the technical features in the above embodiments are not described. However, as long as there is no contradiction between the combinations of these technical features, all should be considered as the scope of this manual.

The above-described embodiments are merely illustrative of several embodiments of the disclosure, and the description thereof is more specific and detailed, but is not to be construed as limiting the scope of the disclosure. It should be noted that, for those of ordinary skill in the art, without departing from the concept of the disclosure, several modifications and improvements can be made, which all belong to the protection scope of the disclosure. Therefore, the protection scope of the disclosure shall be subject to the appended claims.

What is claimed is:

1. A diaphragm assembly, comprising:
a diaphragm body provided with a plurality of magnetized areas; and
a circuit pattern fixedly arranged on the diaphragm body, the circuit pattern comprises a plurality of copper sheets arranged in a one-to-one correspondence with the plurality of magnetized areas, and an isolation gap is arranged between two adjacent copper sheets of the plurality of copper sheets;
at least part of the plurality of copper sheets is provided with a plurality of balance gaps arranged in a width direction of the part of the plurality of copper sheets, and each of the part of the plurality of copper sheets is divided into a plurality of narrow strips.

2. The diaphragm assembly according to claim 1, wherein a copper sheet with a smallest width dimension of the plurality of copper sheets is not provided with the plurality of balance gaps.

3. The diaphragm assembly according to claim 2, wherein a width dimension of each of the plurality of narrow strips is equal to a width dimension of the copper sheet with the smallest width dimension.

4. The diaphragm assembly according to claim 1, wherein a width dimension of the isolation gap is equal to a width dimension of each of the plurality of balance gaps.

5. The diaphragm assembly according to claim 1, wherein a width dimension of each of the plurality of narrow strips is larger than a width dimension of the isolation gap.

6. The diaphragm assembly according to claim 1, wherein all of the plurality of narrow strips belonging to the same copper sheet of the plurality of copper sheets are arranged in parallel.

7. The diaphragm assembly according to claim 1, wherein the plurality of copper sheets are arranged in parallel.

8. The diaphragm assembly according to claim 1, wherein the circuit pattern is bonded to the diaphragm body.

9. The diaphragm assembly according to claim 1, wherein the diaphragm body is made of a material with deformability.

10. A loudspeaker, comprising a magnet configured to provide a magnetic field, a circuit board configured to provide current, and the diaphragm assembly according to claim 1, wherein an end of the circuit pattern is electrically connected to the circuit board.

11. The loudspeaker according to claim 10, wherein the current provided by the circuit board to each of the plurality of copper sheets at the same time is equal.

12. The loudspeaker according to claim 10, wherein a hollow groove is arranged in the middle of the circuit board, and the diaphragm body is fixedly arranged in the hollow groove.

13. The loudspeaker according to claim 10, wherein a copper sheet with a smallest width dimension of the plurality of copper sheets is not provided with the plurality of balance gaps.

14. The loudspeaker according to claim 13, wherein a width dimension of each of the plurality of narrow strips is equal to a width dimension of the copper sheet with the smallest width dimension.

15. The loudspeaker according to claim 10, wherein a width dimension of the isolation gap is equal to a width dimension of each of the plurality of balance gaps.

16. The loudspeaker according to claim 10, wherein a width dimension of each of the plurality of narrow strips is larger than a width dimension of the isolation gap.

17. The loudspeaker according to claim 10, wherein all of the plurality of narrow strips belonging to the same copper sheet of the plurality of copper sheets are arranged in parallel.

18. The loudspeaker according to claim 10, wherein the plurality of copper sheets are arranged in parallel.

19. The loudspeaker according to claim 10, wherein the circuit pattern is bonded to the diaphragm body.

20. The loudspeaker according to claim 10, wherein the diaphragm body is made of a material with deformability.
